(19) United States
(12) Patent Application Publication
(10) Pub. No.: US 2018/0010655 A1
(43) Pub. Date: Jan. 11, 2018

(54) PROTECTIVE COVER FOR DISC

(71) Applicant: Yuan-Hung WEN, Chang Hua County (TW)

(72) Inventor: Yuan-Hung WEN, Chang Hua County (TW)

(21) Appl. No.: 15/640,979

(22) Filed: Jul. 3, 2017

(30) Foreign Application Priority Data
Jul. 5, 2016 (TW) 105121214

(51) Int. Cl. F16D 65/00; B62L 1/00; F16D 65/12; F16D 65/847; F16D 65/02

(52) U.S. Cl. CPC F16D 65/0081; F16D 65/12; F16D 65/847; B62L 1/005; F16D 65/0068; F16D 2065/1392

(57) ABSTRACT

A protective cover for a disc is for being disposed on a fork of a bicycle. The fork has a shaft hole. A direction toward which an opening of the shaft hole faces is defined as an axial direction. The bicycle further has a brake disc. The protective cover includes a shell body. As viewed in the axial direction, the shell body and the brake disc are located by the same side of the bicycle, and the brake disc is shielded by the shell body.

### BACKGROUND OF THE INVENTION

### Field of the Invention

The present invention relates to a cover, and more particularly to a protective cover fora disc.

### Description of the Prior Art

Riding a bicycle for exercise is growing in popularity these years; more and more people are switching to the bicycles. Thus, it provides a huge business opportunity in the bicycle industry. In the field of a brake, a hydraulic disc brake is favored by consumers because of its durability, strong brake force and weather-resistance.

However, when riding the bicycle too fast and unfortunately getting into an accident such as a bicycle-crash or falling off the bicycle, the disc brake may result in brake failure if the disc brake for example crashes into an object. Moreover, when riding the bicycle at the high speed, if the disc brake crashes into a human body, the disc brake will cut the human body as a lethal blade, and can easily rip a body tissue, and leading to skin abrasion and bleeding, or tearing tendons and breaking bones so as to threat the life.

### SUMMARY OF THE INVENTION

The main object of the present invention is to provide a protective cover for a disc, which covers the brake disc effectively, and not only can prevent the disc brake from being crashed, but can prevent the human body from being cut by the disc brake.

To achieve the above and other objects, a protective cover for a disc of the present invention is for being disposed on a fork of a bicycle. The fork has a shaft hole. A direction toward which an opening of the shaft hole faces is defined as an axial direction. The bicycle further has a brake disc. The protective cover includes a shell body. As viewed in the axial direction, the shell body and the brake disc are located by the same side of the bicycle, and the brake disc is shielded by the shell body.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a first preferred embodiment of the present invention;

FIG. 2 is a breakdown drawing showing of the first preferred embodiment of the present invention disposed on a fork of a bicycle;

FIG. 3 is a side view of the first preferred embodiment of the present invention disposed on the fork of the bicycle;

FIGS. 4 is a top plan view of the first preferred embodiment of the present invention disposed on the fork of the bicycle;

FIGS. 5 is a stereogram of a second preferred embodiment of the present invention disposed on the fork of the bicycle;

FIGS. 6 is a breakdown drawing showing of a third preferred embodiment of the present invention disposed on the fork of the bicycle;

FIGS. 7 is a stereogram of the third preferred embodiment of the present invention disposed on the fork of the bicycle.

### DETAILED DESCRIPTION OF THE PREFERRED EMBODIMENTS

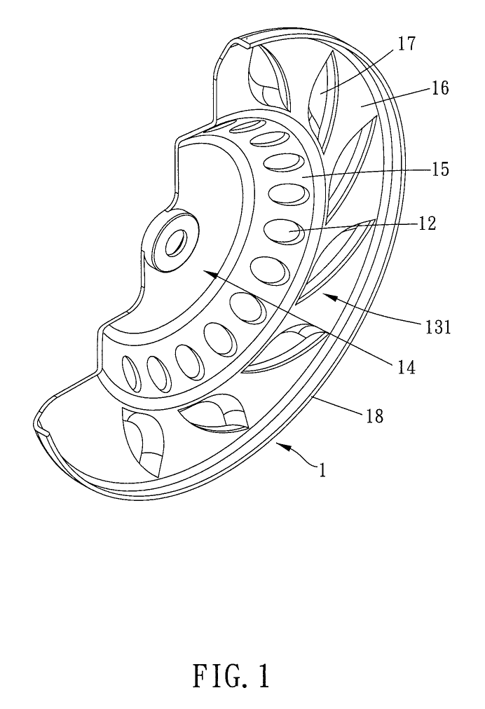

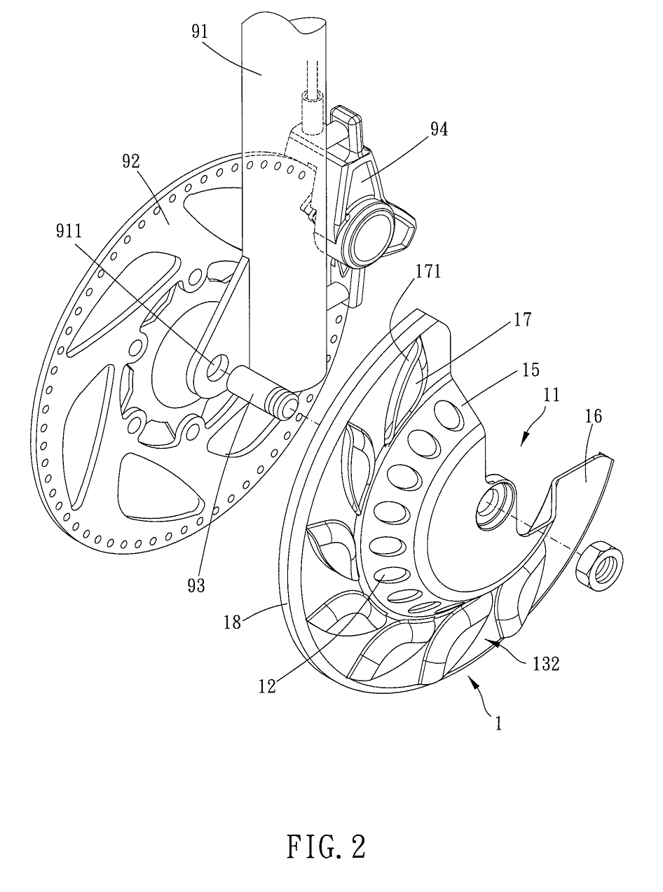

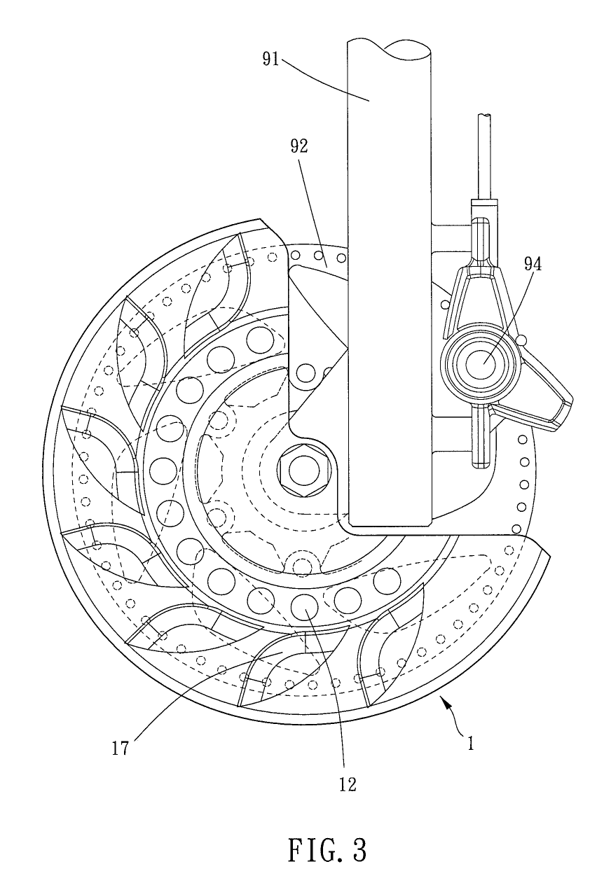

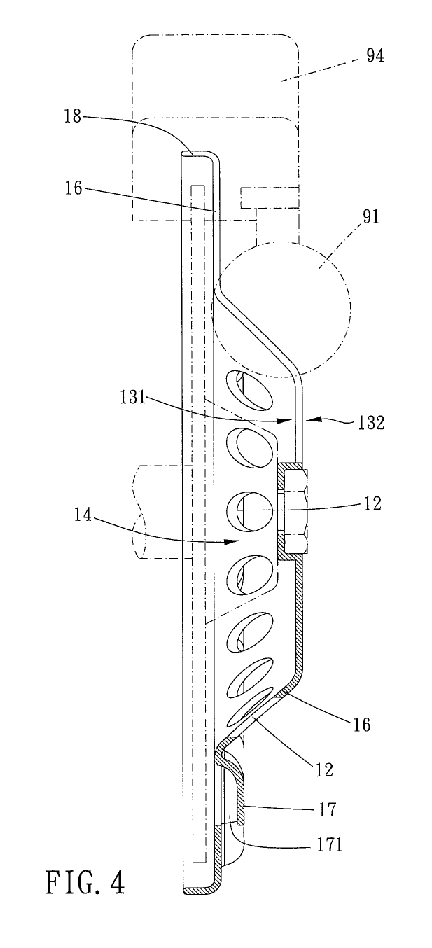

Please refer to FIG. 1 to FIG. 4 for a first preferred embodiment of the present invention, a protective cover for a disc of the present invention is for being disposed on a fork 91 of a bicycle (not shown), the protective cover can be disposed on the fork 91 directly or through other bicycle member such as a brake caliper set 94. The fork 91 having a shaft hole 911, a direction toward which an opening of the shaft hole 911 faces being defined as an axial direction, the bicycle further having a brake disc 92. The protective cover includes a shell body 1.

The shell body 1 is for a shaft 93 to penetrate therethrough; the shaft 93 penetrates through the shaft hole 911 of the fork 91 and further penetrates through a wheel (not shown) of the bicycle. In other embodiments, the shell body 1 can be disposed on the fork 91 of the bicycle (not shown) without the shaft 93 penetrating therethrough. As viewed in the axial direction, the shell body 1 and the disc brake 92 are located by the same side of the bicycle and the shell body 1 covers the disc brake 92, to prevent the disc brake 92 from being damaged by outer objects. Thus, the protective cover for disc can protect the disc brake 92 effectively, and can not only prevent the human body from being ripped by the disc brake 92, but prevent the disc brake 92 from being damaged by the outer objects. Furthermore, in this embodiment a periphery of the shell body has a peripheral flange 18, and the peripheral flange 18 extends toward the brake disc 92 axially and covers the brake disc 92 radially, so as to prevent the brake disc 92 from being damaged radially by the outer objects more effectively.

Specifically, as viewed in the axial direction, the shell body is a three-quarter disc-shaped, the shell body has a notch portion 11, the notch portion 11 is for receiving the brake caliper set 94 of the bicycle, the brake caliper set 94 is for braking the brake disc 92.

Preferably, the shell body 1 has a plurality of through holes 12 arranged circularly, to increase the air circulation around the brake disc 92 so as to enhance the dissipate heat efficiency. Furthermore, the shell body 1 further includes a first surface 131 and a second surface 132 opposite to the first surface 131, the first surface 131 faces the brake disc 92, a central region of the first surface 131 has a recess portion 14, a peripheral of the recess portion 14 includes an inclined surface section 15 therearound, a peripheral of the inclined surface section 15 includes a flat surface section 16, each of the through holes 12 penetrates through the inclined surface section 15, for flowing air into the recess portion 14 axially and radially simultaneously.

It is to be noted that the flat surface section 16 in this embodiment has a plurality of convex portions 17 disposed therearound on the second surface 132, as viewed in the axial direction, each of the convex portions 17 is a triangle-shaped and has an open hole 171 which opens radially outwardly. When riding the bicycle forward, a radial direction of the shell body 1 is on the windward side, air can flow in the shell body 1 through each open hole 171, so as to increase air circulation around the brake disc 92 covered by the shell body 1, to decrease the temperature of the brake disc 92 so that can enhance the dissipate heat efficiency of the brake disc 92.

Given the above, the protective cover for disc of present invention, the shell body 1 and the brake disc 92 are located by the same side of the bicycle, to prevent the brake disc 92 from being damaged by outer objects, thus the protective cover can protect the brake disc 92 effectively, and not only can prevent the human body from being ripped by the disc brake 92, but preventing the disc brake 92 from being crashed by the outer objects.

Besides, the shell body 1 has the peripheral flange 18, and the peripheral flange 18 extends toward the brake disc 92 axially and covers the brake disc 92 radially, so as to prevent the brake disc 92 from being touched radially by the outer objects more effectively.

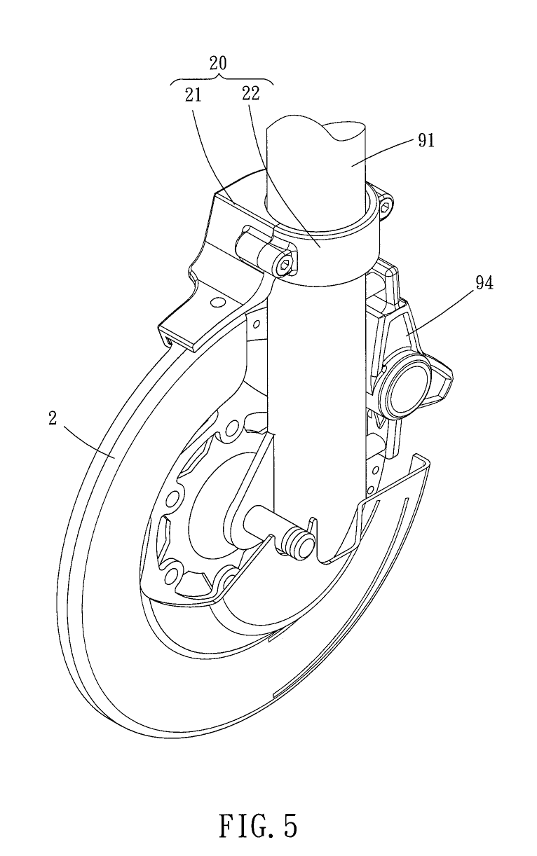

Please refer to FIG. 5 for a second preferred embodiment of the present invention. As compared with the first preferred embodiment, the protective cover further including a retaining ring member 20 which is connected with the shell body 2, the retaining ring member 20 configured to be releasably disposed around the fork 91. Thus, the shell body 2 can be connected to the fork 91 stably. The retaining ring member 20 can be a C ring which is made integrally with the shell body 2, and also can be a clamp. In this embodiment, the retaining ring member 20 includes a base 21 and a secured member 22 which is releasably connected with the base 21, and the base 21 and the secured member 22 form a via hole 23 for penetrating of the fork 91. Wherein, the base 21 can be made integrally with the shell body 2. Specifically, the secured member 22 and the base 21 can be connected by screws.

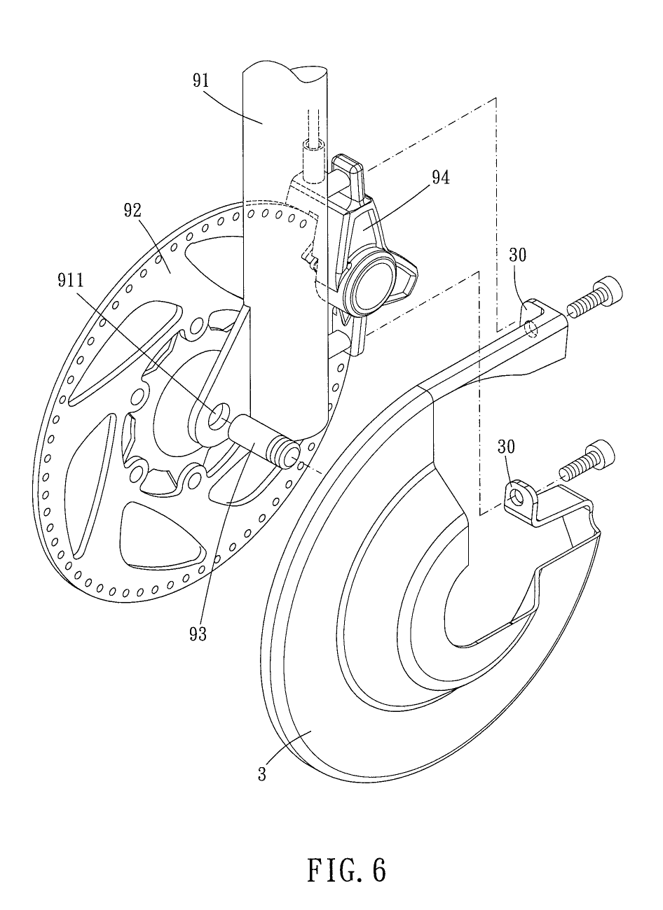

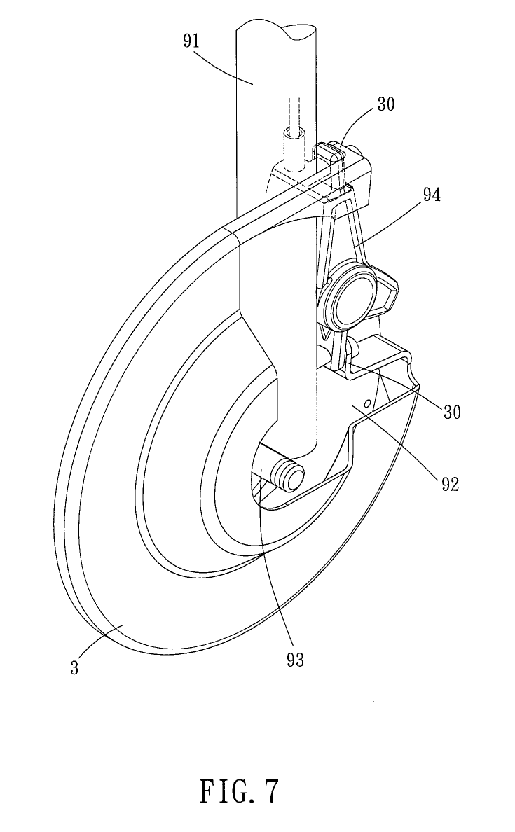

Please refer to FIG. 6 to FIG. 7 for a third preferred embodiment of the present invention. As compared with the first preferred embodiment, the shell body 3 has two connecting portions 30 which are separate from each other, and each of the two connecting portions 30 is configured to be detachably fixed to the brake caliper set 94 attached to the fork 91 of the bicycle. Thus, the shell body 3 can be connected with the brake caliper set 94 stably. Specifically, the two connecting portions 30 can be connected with the brake caliper set 94 by the screws.

What is claimed is:

1. A protective cover for a disc for being disposed on a fork of a bicycle, the fork having a shaft hole, a direction toward which an opening of the shaft hole faces being defined as an axial direction, the bicycle further having a brake disc, the protective cover including:
a shell body, as viewed in the axial direction, the shell body and the brake disc located by the same side of the bicycle, and the brake disc shielded by the shell body.

2. The protective cover of claim 1, wherein as viewed in the axial direction, the shell body is a three-quarter disc-shaped, the shell body has a notch portion, the notch portion is for receiving a brake caliper set of the bicycle.

3. The protective cover of claim 1, wherein the shell body has a plurality of through holes arranged circularly.

4. The protective cover of claim 3, wherein the shell body further includes a first surface and a second surface opposite to the first surface, the first surface faces the brake disc, a central region of the first surface has a recess portion, a peripheral of the recess portion includes an inclined surface section therearound, a peripheral of the inclined surface section includes a flat surface section, each of the through holes penetrates through the inclined surface section.

5. The protective cover of claim 4, wherein the flat surface section has a plurality of convex portions disposed therearound on the second surface, as viewed in the axial direction, each of the convex portions is a triangle-shaped and has an open hole which opens radially outwardly.

6. The protective cover of claim 1, wherein a periphery of the shell body has a peripheral flange, and the peripheral flange extends toward the brake disc axially and covers the brake disc radially.

7. The protective cover of claim 5, wherein as viewed in the axial direction, the shell body is a three-quarter disc-shaped, the shell body has a notch portion, the notch portion is for receiving a brake caliper set of the bicycle; a periphery of the shell body has a peripheral flange, and the peripheral flange extends toward the brake disc axially and covers the brake disc radially.

8. The protective cover of claim 1, further including a retaining ring member which is connected with the shell body, the retaining ring member configured to be releasably disposed around the fork.

9. The protective cover of claim 8, wherein the retaining ring member includes a base and a secured member which is releasably connected with the base, and the base and the secured member form a via hole for penetrating of the fork.

10. The protective cover of claim 1, wherein the shell body has two connecting portions which are separate from each other, and each of the two connecting portions is configured to be detachably fixed to a brake caliper set attached to the fork of the bicycle.
